(19) United States
(12) Patent Application Publication
(10) Pub. No.: US 2009/0298406 A1
(43) Pub. Date: Dec. 3, 2009

(54) ILLUMINATED VENT HOUSING

(76) Inventors: Raymond L. Norbury, JR., Duncanville, TX (US); John W. Baker, DeSoto, TX (US); Bobby Pannell, Argyle, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/132,392

(22) Filed: Jun. 3, 2008

(51) Int. Cl. B60H 1/00; B60Q 3/00; B60H 1/26

(52) U.S. Cl. 454/69; 362/459; 454/145

(57) ABSTRACT

An illuminated vent for a fluid circulation system is disclosed. The vent may include a base, a louver configured to influence the direction of fluid passing through the vent, and one or more light sources coupled to the base and/or to the louver. Illumination provided by at least one of the light sources may be aesthetically pleasing and/or facilitate location of vent.

### BACKGROUND

1. Field of the Invention

The present invention generally relates to vents through which fluid flows. More particularly, the invention relates to illuminated vents that are aesthetically pleasing and facilitate location of the vent in low light situations.

2. Description of Related Art

Vents may be used to control the flow of fluid. For example, vents may be used to direct air from circulation systems into rooms or vehicles. In some systems, the air may be cooled by an air conditioning system or heated by a heating system. Vents may be used to direct water from a circulation system into a container or vessel. Vents may be used for other situations and with other fluids. A fluid may be, but is not limited to, a gas, a liquid, an emulsion, a slurry, and/or a stream of solid particles that has flow characteristics similar to liquid flow.

A vent may include a base and a louver. In some embodiments, the base and/or the louver may be assembled from two or more component parts. The vent base may have a fluid entrance and a fluid exit. The fluid entrance may be coupled to a fluid supply (for example, an air conditioning and/or a heater system). The louver may be coupled to the vent base. The louver control the direction of fluid exiting the vent. The louver may include one or more vanes or blades that direct the flow of fluid exiting the vent. In some embodiments, the louver may be stationary. In some embodiments, the louver may move and/or rotate relative to the base. Adjustment of the louvers may control the direction of fluid exiting the vent. Adjustment of the louver may allow for control of the amount of fluid exiting the vent. When the louver is in a closed position, flow of fluid through the vent may be inhibited.

### SUMMARY

Embodiments described herein generally relate to systems and methods for providing fluid flow from fluid circulation systems.

An embodiment of a vent comprises a base, a louver coupled to the base, and one or more light sources coupled to the base. The louver is configured to influence the direction of fluid passing through the vent. At least one of the light sources is configured to illuminate the vent.

An embodiment of a vent comprises a base, a louver coupled to the base, and one or more light sources coupled to the louver. The louver is configured to influence the direction of fluid passing through the vent. At least one of the light sources is configured to illuminate the vent.

An embodiment of a vent system comprises a vent base coupled to a ventilation system for supplying fluid, one or more light sources coupled to the vent base, and wherein at least one of the one or more light sources is electrically coupled to an electrical system. For example, the vent system may be an air circulation system for building (e.g., a house, office, or warehouse). The electrical system may be a power system for the building. In some embodiments, a control system may be coupled to the power system to provide power to the one or more light sources upon fulfillment of one or more conditions.

An embodiment of a vent system for a vehicle comprises a vent base coupled to a ventilation system of the vehicle, one or more light sources coupled to the vent base, and wherein at least one of the one or more light sources is electrically coupled to an electrical system of the vehicle.

In some of the embodiments, covers may protect the light sources. In some of the embodiments, the intensity of the light emitted by one or more of the light sources is adjustable. In further embodiments, features from one embodiment may be combined with features from any of the other embodiments.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a perspective view of an embodiment of a vent with an illuminated base.

FIG. 2 depicts an exploded view of the vent embodiment depicted in FIG. 1.

FIG. 3 depicts a cross-sectional view of the vent embodiment depicted in FIG. 1 taken substantially along plane A-A of FIG. 1.

FIG. 4 depicts a front view of embodiment of a vent with an illuminated base.

FIG. 5 depicts a perspective view of an embodiment of a vent with an illuminated louver.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION

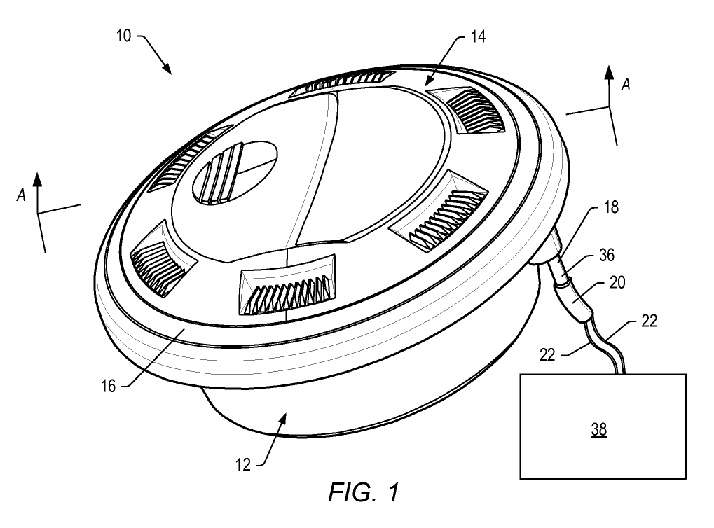

FIG. 1 depicts an embodiment of assembled vent 10. Vent 10 may include base 12, louver 14, cover 16, and light source 18. A portion of light source 18 may be positioned under cover 16. Connector 20 and wiring 22 may be attached to light source 18. When wiring 22 is electrically coupled to a power supply and energized, the light source may illuminate. The illumination provided by light source 18 may enhance the appearance of the vent, be aesthetically pleasing, and/or facilitate location of vent 10. Vents may be used in buildings, vehicles, equipment, presentation booths, or other structures. Vehicles may include, but are not limited to, cars, trucks, motorcycles, motorhomes, travel trailers, boats, ships, heavy duty trucks such as diesel rigs, construction equipment, and off-road equipment.

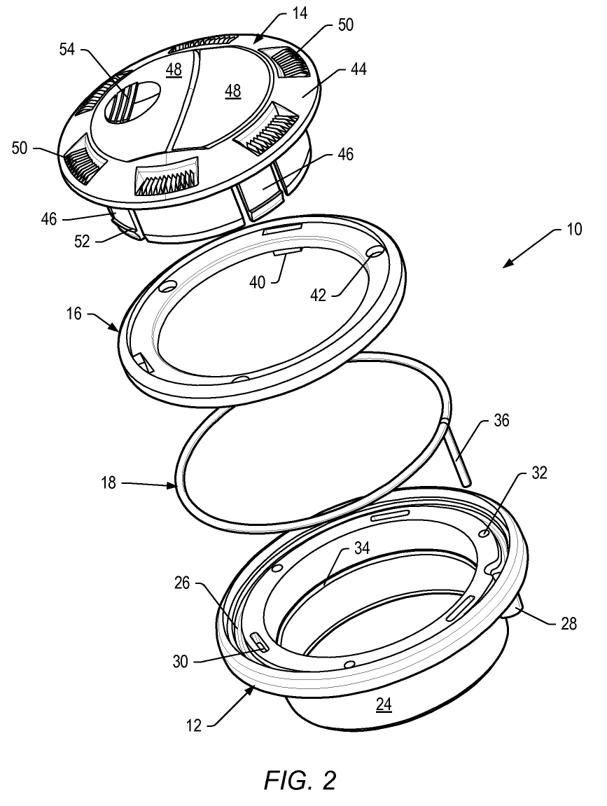

FIG. 2 depicts an exploded view of vent 10. Base 12 may include hose connector 24, groove 26, light source port 28, slots 30, openings 32, and ridge 34. A hose may be coupled to hose connector 24 to direct fluid from a fluid source to the vent. The hose may be a duct of a ventilation, air conditioning and/or heating system, a water hose, or other fluid carrying conduit.

A portion of light source 18 may fit in groove 26 of base 12. Extension 36 of light source 18 may pass through light source opening port 28. After extension 36 is positioned through light source port 28 in base 12, the remaining portion of light source 18 may be seated in groove 26. As depicted in FIG. 1, connector 20 and wiring 22 from electrical system 38 may be coupled to extension 36 of light source 18. In some embodiments, connector 20 is a quick release type of electrical connection to facilitate separation of vent 10 and/or light source 18 from the electrical system 38. Electrical system 38 may be a battery powered system and/or attached to an electrical grid. In some embodiments, electrical system 38 is an electrical system of a vehicle or an electrical system of a building.

Light source 18 may be any type of light source, including but not limited to, lighted fiber optic cable, incandescent light, fluorescent light, one or more light emitting diodes (LEDs), an arc light, or other cathode/anode electrical discharge devices that produce light. One type of light source that may be used is a Glowire device (available from Glowire, LaOtto, Ind., U.S.A.). In some embodiments, light sources 18 produce white light. In some embodiments, light sources 18 produce other colors of light. For example, light sources 18 may produce red, green, blue, or other colors of light. In some embodiments, cover 16 may control the color of light perceived by an observer. Cover 16 may be clear, colored, opaque, textured or otherwise modified to control the color and/or lighting effects.

In some embodiments, electrical system 38 coupled to light source 18 includes a rheostat or other controller that allows for adjustment of the intensity of the light produced by the light source. For example, the light source may be coupled to the portion of an electrical system of a vehicle that provides illumination to the dashboard and gauges of the vehicle. The intensity of the light provided by the portion of the electrical system may be controlled by rotating a dashboard illumination knob of the vehicle, or by moving a dashboard illumination slide. In an embodiment, the vent is a vent in a building, and the light source is coupled to an electrical system of the building (for example, the building may be house, office, warehouse or other building). A control system may be electrically coupled to the electrical system so that power is supplied to the light source upon fulfillment of one or more conditions. Such conditions may include, but are not limited to, upon user demand, upon turning off of the primary illumination source or sources in the vicinity of the vent, and/or upon adjustment of the vent.

In some embodiments, the electrical system 38 may include a timer. The timer may allow illumination of the vent for a set period of time. For example, when a control for the fluid circulation system that the vent is coupled to is changed, the timer of the electrical system may illuminate the light source for 15 seconds. The control for the fluid circulation system may be, but is not limited to, temperature control and/or flow rate control of a ventilation, air conditioning and/or heater system, change of fluid flow from one system of vents to a different system of vents, and/or change of position of a louver in a vent. The illumination of the light source facilitates the ability of a user to find and adjust the outflow from the vent. After the time period, power to the light source may fade or be stopped and the light source will not provide additional illumination until another control is adjusted.

In some embodiments, the light source may provide a steady light output. In other embodiments, the light source may be able to provide a steady light output and/or flashing light, blinking light, traveling light that progresses around the path of the light source, and/or other varying light output patterns.

As shown in FIG. 2, vent 10 may include cover 16. In some embodiments, vent 10 includes more than one cover 16. In some embodiments, more than one cover 16 is used so that more than one color of illumination is visible to a user along the length of light source and/or to adjust the color visible to an observer. In some embodiments, the vent may not include a cover. Cover 16 may include one or more positioners 40, and one or more openings 42. Positioners 40 may align openings 42 with openings 32 in base 12. Positioners 40 may fit in one or more slots 30 in base 12. In some embodiments, positioners 40 may be flexible members with a ledge that engages a bottom portion of base 12 to inhibit separation of cover 16 from the base.

Shafts of fasteners (for example, screws) may be positioned through openings 42, 32 to couple vent 10 to a support structure (for example, a dashboard of a vehicle). Openings 42 may be countersunk so that the heads of the fasteners do not extend above cover 16. In other embodiments, other fastening systems may be used to couple the vent to the support structure.

A bottom portion of louver 14 may be positioned through the central opening of cover 16 into base 12. Louver 14 may include body 44, flexible arms 46, blades 48, and contoured portions 50. Flexible arms 46 may include ledge 52. When louver 14 is positioned in base 12, flexible arms 46 may be pushed inwards when the slanted bottom portion passes across ridge 34 of the base. When ledges 52 passes ridge 34, flexible arms 46 move outwards and interaction between the ridge and the ledges inhibits separation of louver 14 from base 12 while still allowing the louver to be rotated relative to the base. Textured portions 50 may facilitate rotation of louver 14 relative to base 12. A user may put fingertips on textured portions 50 and rotate louver 14 clockwise and/or counterclockwise relative to base 12.

Louver 14 may include one or more blades 48. Blades 48 may direct fluid flowing through vent 10 in a desired direction. One or more of blades 48 may include textured portion 54. A user may push on textured portion 54 to activate a linkage system that allows for simultaneous opening of blades. In the closed position, fluid flow through vent 10 is inhibited. When blades 48 are in an open position, the position of the blades alters the direction of flow of fluid exiting vent 10. To return blades 48 to the closed position, the user contacts an upper portion of a blade and moves the blade to the closed position.

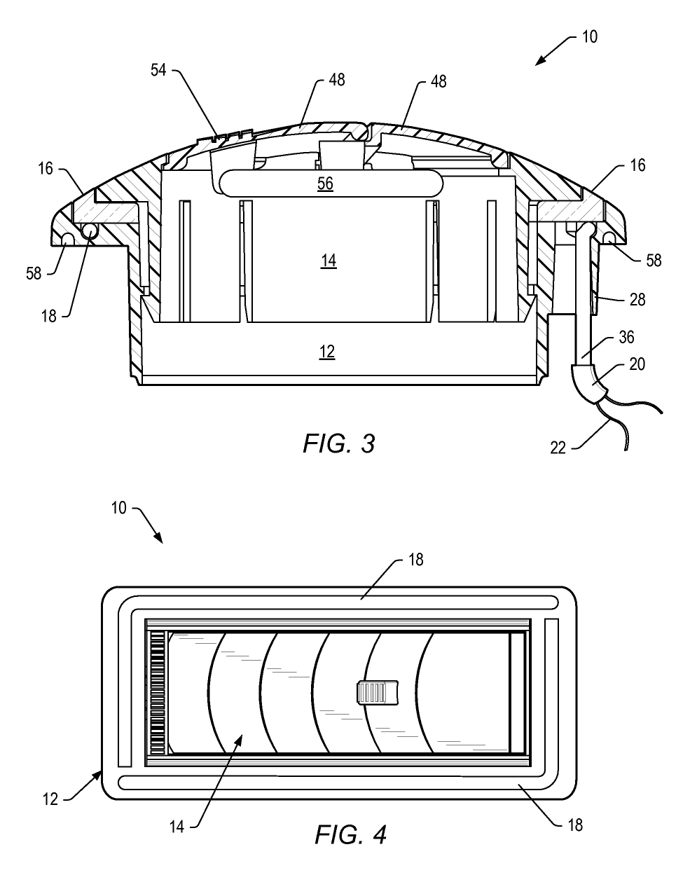

FIG. 3 depicts a cross-sectional view of vent 10 taken substantially along plane A-A of FIG. 1. Louver includes linkage system 56. Linkage system 56 may include axle sockets extending from blades 48, axles that couple to the axle sockets and/or the louver body, and connecting links between axles.

Base 12 may include groove 58. Groove 58 may reduce the amount of material needed to form base 12. If the base 12 is injection molded from a polymeric material, groove 58 may help to reduce perimeter shrinkage during formation that may distort the shape of the base.

Base 12, and louver 14 may be made of plastic, metal, ceramics and/or other material. In some embodiments, base 12, and/or louver 14 may be injected molded from a polymeric material (e.g., ABS (Acrylonitrile Butadiene Styrene) copolymer, nylon and/or polypropylene). Cover 16 may be made of a transparent or semi-transparent or opaque material. The material may be a polymer or glass. Cover 16 may be surfaced textured and/or dyed so that light emitted from the vent has a desired color and/or appearance.

In other embodiments, the vent may be a different type of vent. For example, the vent may be a ball louver. In a ball louver, a rotatable ball is positioned in the base. The ball may include a central vane. When the vent is in the closed position, the vane substantially blocks the base and inhibits fluid flow through the ball louver. In an open position, the vane allows fluid flow through the base and the direction of fluid exiting the vent is influenced by the position of the vane.

In some embodiments, the vent may have a non-circular front view. FIG. 4 depicts vent 10 with a non-circular front view. Vent 10 includes base 12, louver 14, and light sources 18. Light sources 18 partially surround louver 14 of vent 10. A fluid such as air passes through louver 14 when the louver is in an open position. In some embodiments, light sources 18 are located beneath covers.

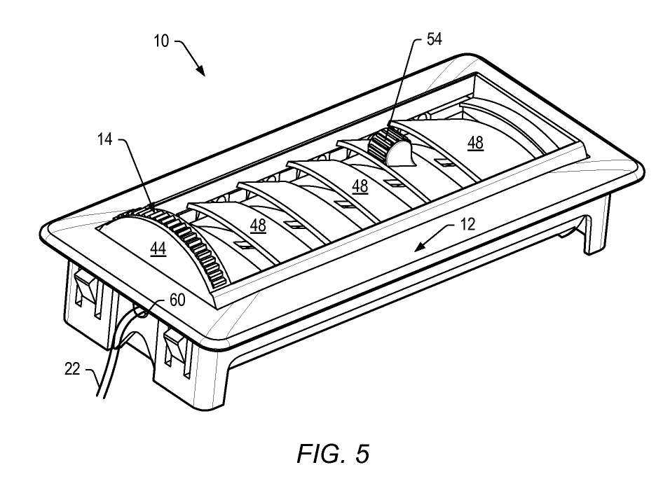

In some embodiments, one or more light sources may be coupled to the louver of the vent. For example, light sources may be positioned in louver body 44 and/or in textured portion 54 of louver 14 depicted in FIG. 5. Wiring 22 for the light sources may pass to louver body 44 and/or portions of blades 48 through hollow axle 60 that couples to the base of vent 10. Blades 48 are depicted in a partially open position.

The illuminated vent may be electrically coupled to an electrical system to provide power to the light source or light sources of the vent. For example, the light source of the vent is coupled to the electrical system of a vehicle. A fluid supply may be coupled to the vent. For example, an air duct of the air circulation system of the vehicle is coupled to the vent. The vent may be attached to a support structure. For example, the vent is coupled to the dashboard of the vehicle by fasteners such as screws. When the electrical system supplies electricity to the light source or light sources, the vent is illuminated. In some embodiments, a louver of the vent may be adjusted to allow for fluid flow out of the vent and/or to control the direction of fluid flow out of the vent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A vent, comprising:
a base;
a louver coupled to the base, the louver configured to influence the direction of fluid passing through the vent; and
one or more light sources coupled to the base, at least one light source configured to illuminate the vent.

2. The vent of claim 1, further comprising one or more covers configured to protect the one or more light sources.

3. The vent of claim 1, wherein louver is configured to rotate relative to the base.

4. The vent of claim 1, wherein louver is configured to inhibit fluid flow through vent when the louver is in a closed position.

5. The vent of claim 1, wherein the vent is a portion of an air circulation system of a vehicle, and wherein a light source of the one or more light sources is coupled to the electrical system of the vehicle.

6. The vent of claim 5, wherein the electrical system energizes at least one light source for a desired time upon adjustment of a control of the air circulation system.

7. The vent of claim 1, wherein the vent is a portion of a circulation system for a building, and wherein a light source of the one or more light sources is coupled to the electrical system of the building.

8. The vent of claim 1, further comprising a controller configured to adjust the brightness of light emitted from at least one light source.

9. A vent, comprising:
a base;
a louver coupled to the base, the louver configured to influence the direction of fluid passing through the vent; and
one or more light sources coupled to the louver, at least one light source configured to illuminate the vent.

10. The vent of claim 9, further comprising one or more covers configured to protect the one or more light sources.

11. The vent of claim 9, wherein the louver is configured to rotate relative to the base.

12. The vent of claim 9, wherein the vent is coupled to an air circulation system of a vehicle.

13. The vent of claim 9, wherein the vent is a portion of a circulation system for a building.

14. The vent of claim 9, further comprising a controller configured to adjust the brightness of light emitted from at least one light source.

15. The vent of claim 9, wherein the vent is a portion of an air circulation system of a vehicle, and wherein the light source is coupled to the electrical system of the vehicle.

16. The vent of claim 15, wherein the electrical system energizes at least one light source for a desired time upon adjustment of a control of the air circulation system.

17. The vent of claim 9, further comprising one or more light sources coupled to the base.

18. A vent system for a vehicle, comprising:
a vent coupled to a ventilation system of the vehicle;
one or more light sources coupled to the vent, where the one or more light sources at least partially surround an air outlet of the vent; and
wherein at least one of the one or more light sources is electrically coupled to an electrical system of the vehicle.

19. The vent system of claim 18, further comprising one or more covers over at least one light source.

20. The vent system of claim 18, wherein the vent comprises a louver configured to influence direction of air flow from the vent housing, and wherein the light source is coupled to the louver.

21. The vent system of claim 18, wherein the vent comprises a base configured to couple to a an air supply conduit of the ventilation system, and wherein at least one light source is coupled to the base.

22. The vent system of claim 18, wherein an intensity of light provided by at least one of the light sources is adjustable by a control coupled to the electrical system.
